(19) United States
(12) Patent Application Publication
(10) Pub. No.: US 2013/0155122 A1
(43) Pub. Date: Jun. 20, 2013

(54) APPARATUS AND METHOD OF DRIVING DISPLAY DEVICE

(71) Applicants: Kyung-Uk CHOI, Gunpo-si (KR); Byeong-Doo KANG, Daegu (KR); Yong Soon LEE, Cheonan-si (KR); Jeong Bong LEE, Busan (KR)

(72) Inventors: Kyung-Uk CHOI, Gunpo-si (KR); Byeong-Doo KANG, Daegu (KR); Yong Soon LEE, Cheonan-si (KR); Jeong Bong LEE, Busan (KR)

(73) Assignee: SAMSUNG ELECTRONICS CO., LTD., Suwon-si (KR)

(21) Appl. No.: 13/438,412

(22) Filed: Apr. 3, 2012

(30) Foreign Application Priority Data
Dec. 16, 2011 (KR) 10-2011-0136786

(51) Int. Cl. G09G 5/10

(52) U.S. Cl. 345/690

(57) ABSTRACT

A driving apparatus of a display device includes: a panel driving unit that receives a panel control signal and a first light control signal from an external device, drives a display panel of the display device based on the panel control signal, processes the first light control signal, and outputs the processed first light control signal as a second light control signal; and a light driving unit that drives the light source based on the second light control signal, where the second light control signal is configured to have the light source provide light for the display panel after a completion of a pre-display operation of the panel driving unit.

This application claims priority to Korean Patent Application No. 10-2011-0136786, filed on Dec. 16, 2011, and all the benefits accruing therefrom under 35 U.S.C. §119, the content of which in its entirety is herein incorporated by reference.

### BACKGROUND OF THE INVENTION

1. Field of the Invention

Provided is an apparatus and a method of driving a display device.

2. Description of the Related Art

Flat panel displays that are widely used at current times may be classified into an emissive type that emits light by itself and a non-emissive type that does not emit light and requires a separate light source. The emissive type display device may include a light emitting organic display (“OLED”), and the non-emissive type display device may include a liquid crystal display (“LCD”).

The non-emissive type display device may include a display panel for displaying images and a light source for supplying light for the display panel. The display panel may adjust the intensity of the light from the light source to display desired images.

The non-emissive type display device may be used in an electronic device such as a television (“TV”), a monitor and a cell phone, for example, and may operate based on video signals and control signals received from the electronic device. Currently, it is common that the electronic device individually generates and supplies a panel control signal only for the display panel of the display device and a light control signal only for the light source. The display panel operates in response to the panel control signal, while the light source operates in response to the light control signal.

In such a non-emissive display device, pre-display operations of the display panel may be completed before the light generated by the light source is supplied for the display panel, such that unexpected images may be displayed. Recently, the functions of a signal controller for controlling the display panel have become complicated and thus a time for the pre-display operation tend to be longer. Therefore, the possibility for unexpected images to be displayed may be increased.

### BRIEF SUMMARY OF THE INVENTION

An exemplary embodiment of a driving apparatus of a display device includes: a panel driving unit that receives a panel control signal and a first light control signal from an external device, drives a display panel of the display device based on the panel control signal, processes the first light control signal, and outputs the processed first light control signal as a second light control signal; and a light driving unit that drives the light source based on the second light control signal, where the second light control signal is configured to have the light source provide light for the display panel after a completion of a pre-display operation of the panel driving unit.

In an exemplary embodiment, the second light control signal may be obtained by delaying the first light control signal, and the delay between the first light control signal and the second light control signal may be greater than or equal to a pre-display operation time, during which the pre-display operation of the panel driving unit is performed.

In an exemplary embodiment, the panel driving unit may include: a memory that stores panel information of the display panel; and a signal controller that receives an image signal from the external control device, reads the panel information stored in the memory, and processes the image signal based on the read panel information, where the pre-display operation comprises the reading of the panel information.

In an exemplary embodiment, the first light control signal may include information on luminance of the light source, and the second light control signal may be configured to have the luminance of the light source substantially equal to zero during the pre-display operation, and configured to raise the luminance of the light source after the completion of the pre-display operation of the panel driving unit.

In an exemplary embodiment, the signal controller may include: an image signal processing unit that receives an image signal from the external control device, reads the panel information stored in the memory, generates a reading completion signal, and processes the image signal based on the read panel information, where the reading completion signal informs whether the reading of the panel information is completed; and a signal selection unit that selects one of the first light control signal and a low voltage based on the reading completion signal, and outputs the selected one of the first light control signal and the low voltage as the second light control signal.

In an exemplary embodiment, the signal controller may convert the image signal from the external control device to a data signal and may generate a gate control signal and a data control signal based on the read panel information, the panel driving unit may further include: a voltage generator that receives a panel voltage signal from the external control device, and generates a digital voltage and an analog voltage based on the panel voltage signal; a gate driver that generates a gate signal using the analog voltage from the voltage generator, and applies the gate signal to the display panel based on the gate control signal; and a data driver that converts the data signal into a data voltage using the analog voltage from the voltage generator, and applies the data voltage to the display panel based on the data control signal, where the voltage generator may receive the reading completion signal and may adjust an output timing of the analog voltage based on the reading completion signal, and the display panel may display an image based on the data voltage.

In an exemplary embodiment, the signal controller may include: an image signal processing unit that receives the image signal from the external control device, reads the panel information stored in the memory, generates a reading completion signal, and processes the image signal based on the read panel information, where the reading completion signal informs whether the reading of the panel information is completed; a delay unit that delays the reading completion signal; and a signal selection unit that selects one of the first light control signal and the low voltage based on the delayed reading completion signal, and outputs the selected one of the first light control signal and the low voltage as the second light control signal.

In an exemplary embodiment, the first light control signal may include information on a timing to start an operation of the light driving unit, and the second light control signal may be configured to have the light driving unit start operation after the completion of the pre-display operation of the panel driving unit.

In an exemplary embodiment, the signal controller may generate a voltage generator operation signal, which informs whether the reading of the panel information is completed, and the signal controller may convert the image signal from the external control device to a data signal and may generate a gate control signal, and a data control signal based on the read panel information. In such an embodiment, the panel driving unit may further include: a voltage generator that generates a digital voltage and an analog voltage; an AND gate that receives the first light control signal from the external control device, receives the analog voltage from the voltage generator, and performs a logical product of the first light control signal and the analog voltage to generate the second light control signal; a gate driver that generates a gate signal using the analog voltage from the voltage generator and applies the gate signal to the display panel based on the gate control signal; and a data driver that converts the data signal into a data voltage using the analog voltage from the voltage generator and applies the data voltage to the display panel based on the data control signal. In such an embodiment, the voltage generator may receive the voltage generator operation signal and may adjust an output timing of the analog voltage based on the voltage generator operation signal, and the display panel may display an image based on the data voltage.

In an exemplary embodiment, the first light control signal may include information on luminance of the light source, and the second light control signal may be configured to have the luminance of the light source substantially equal to zero during the pre-display operation, and may be configured to raise the luminance of the light source after the completion of the pre-display operation of the panel driving unit.

In an exemplary embodiment, the panel driving unit may include: a memory that stores panel information of the display panel; and a signal controller, where the signal controller may read the panel information during the pre-display operation time. In such an embodiment, the signal controller may include: an image signal processing unit that receives an image signal from the external control device, reads the panel information stored in the memory, generates a reading completion signal, and processes the image signal based on the read panel information, where the reading completion signal informs whether the reading of the panel information is completed; a delay unit that delays the reading completion signal to generate a selection signal; and a signal selection unit that selects one of the first light control signal and a low voltage based on the selection signal and outputs the selected one of the first light control signal and the low voltage as the second light control signal.

In an exemplary embodiment, the first light control signal may represent information on a timing for the light driving unit to start operation, and the second light control signal may be configured to have the light driving unit to start operation after the panel driving unit finishes the pre-display operation.

In an exemplary embodiment, the panel driving unit may include: a memory that stores panel information of the display panel; and a signal controller that receives an image signal from the external control device, reads the panel information stored in the memory, generates a voltage generator operation signal, and converts the image signal from the external control device to a data signal and generates a gate control signal and a data control signal based on the read panel information, a voltage generator that generates a digital voltage and an analog voltage; an AND gate that receives the first light control signal from the external control device, receives the analog voltage from the voltage generator, and performs a logical product of the first light control signal and the analog voltage to generate the second light control signal; a gate driver that generates a gate signal using the analog voltage from the voltage generator, and applies the gate signal to the display panel based on the gate control signal; and a data driver that converts the data signal into a data voltage using the analog voltage from the voltage generator, and applies the data voltage to the display panel based on the data control signal, where the voltage generator may receive the voltage generator operation signal and may adjust an output timing of the analog voltage based on the voltage generator operation signal, and the display panel may display an image based on the data voltage.

An exemplary embodiment of a driving apparatus of a display device includes: a panel driving unit that receives a panel voltage signal and an image signal from an external device, drives the display panel based on the panel voltage signal and the image signal, and generates an analog signal; an AND gate that receives a lighting start signal from the external control device and outputs a lighting delay signal based on a logical product of the lighting start signal and the analog voltage; and a light driving unit that receives a light source voltage signal and a luminance control signal from the external control device, and receives the lighting delay signal from the AND gate, starts an operation thereof based on the light source voltage signal and the lighting delay signal, and drives the light source based on the luminance control signal, where the lighting delay signal is configured to have the light driving unit start operation after a completion of a pre-display operation of the panel driving unit.

In an exemplary embodiment, the panel driving unit may include: a voltage generator that receives the panel voltage signal and generates a digital voltage and an analog voltage based on the panel voltage signal; a memory that stores panel information of the display panel; a signal controller that receives the image signal, reads the panel information stored in the memory, generates a voltage generator operation signal, converts the image signal into a data signal, and generates a gate control signal and a data control signal based on the read panel information, where the voltage generator operation signal informs whether the reading of the panel information is completed; a gate driver that generates a gate signal using the analog voltage from the voltage generator, and applies the gate signal to the display panel based on the gate control signal; and a data driver that converts the data signal into a data voltage using the analog voltage from the voltage generator, and applies the data voltage to the display panel based on the data control signal. In such an embodiment, the signal controller may read the panel information during a pre-display operation time for the pre-display operation, the voltage generator may receive the voltage generator operation signal and adjust an output timing of the analog voltage based on the voltage generator operation signal, and the display panel displays an image based on the data voltage.

An exemplary embodiment of a method of driving a display device includes: receiving a panel voltage signal, an image signal, a lighting voltage signal, a luminance control signal, and a lighting start signal from an external control device, where a display panel of the display device operates based on the panel voltage signal and the image signal, and a light source of the display device operates based on the lighting voltage signal, the luminance control signal and the lighting start signal; reading panel information of the display panel; processing the image signal based on the read panel information to drive the display panel; generating a delay signal by delaying one of the luminance control signal and the lighting start signal by a time greater than or equal to a time for reading the display panel; and supplying the display panel with light from the light source based on the delay signal.

### BRIEF DESCRIPTION OF THE DRAWINGS

The above and other features of the invention will become more apparent by describing in further detail exemplary embodiments thereof with reference to the accompanying drawings, in which:

FIG. 1 is a block diagram showing an exemplary embodiment of a display device.

FIG. 2 is a block diagram showing an exemplary embodiment of a driving apparatus of a display device.

FIG. 3 is a waveform diagram showing signals of the driving apparatus shown in FIG. 2.

FIG. 4 is a block diagram showing an exemplary embodiment of a signal controller.

FIG. 5 is a block diagram of an alternative exemplary embodiment of a display device.

FIG. 6 is a schematic diagram showing an exemplary embodiment of a display panel for a display device.

FIG. 7 is a waveform diagram showing signals of the display device shown in FIG. 5.

FIG. 8 is a block diagram showing another alternative exemplary embodiment of a display device.

### DETAILED DESCRIPTION OF THE INVENTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims set forth herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

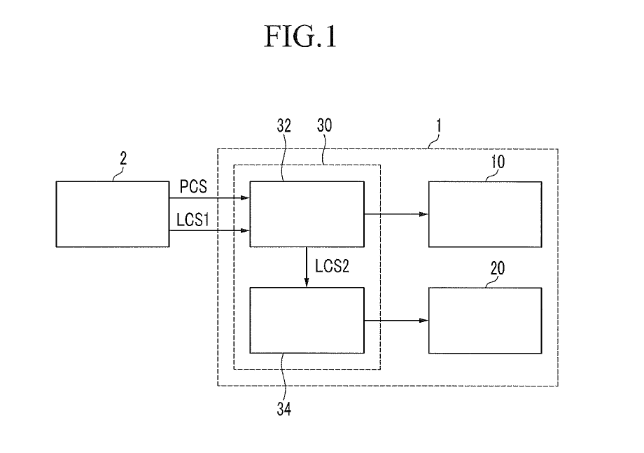

An exemplary embodiment of a display device will now be described in detail with reference to FIG. 1.

FIG. 1 is a block diagram showing an exemplary embodiment of a display device.

Referring to FIG. 1, an exemplary embodiment of a display device 1 is connected to an external control device 2, which may control an electronic device such as television (“TV”), a monitor and a cell phone, for example. In an exemplary embodiment, the display device 1 may be a portion of the electronic device.

The display device 1 includes a display panel 10 which displays an image, a light source 20 which supplies the display panel 10 with light, and a driving apparatus 30 which drives the display panel 10 and the light source 20. The driving apparatus 30 includes a panel driving unit 32 and a light driving unit 34.

In an exemplary embodiment, the panel driving unit 32 is connected to the display panel 10 and the external control device 2, and drives the display panel 10 under the control of the external control device 2. In an exemplary embodiment, the light driving unit 34 is connected to the panel driving unit 32 and the light source 20, and drives the light source 20 under the control of the panel driving unit 32.

In an exemplary embodiment, the external control device 2 generates a panel control signal PCS for controlling the display panel 10 and a first light control signal LCS1 for controlling the light source 20. The first light control signal LCS1, for example, may control the luminance of the light source 20 or may have the light driving unit 34 start operation.

The panel driving unit 32 drives the display panel 10 based on the panel control signal PCS. The panel driving unit 32 performs a normal display operation after performing at least one pre-display operation of the display panel 10, which is performed before displaying a normal image. In an exemplary embodiment, the pre-display operation may include reading information about the display panel 10. In one exemplary embodiment, for example, the information about the display panel 10 may be a resolution from a memory, e.g., an internal memory (not shown).

The panel driving unit 32 also generates a second light control signal LCS2 for controlling the light source 20 based on the first light control signal LCS1. The second light control signal LCS2 may be configured such that the light source 20 supplies the display panel 10 with light after the panel driving unit 32 finishes the pre-display operation. The second light control signal LCS2 may be obtained by delaying the first light control signal LCS1 by a predetermined time.

In an exemplary embodiment, the first light control signal LCS1 generated by the external control device 2 may be configured based on the time for the pre-display operation such that the light source 20 provides the display panel 10 with light after a predetermined delay time from the beginning of an operation of the panel driving unit 32. The external control device 2 and the display device 1 may be separately provided, and the external control device 2 may select a length of the predetermined delay time independently of the display device 1, that is, without considering the characteristics of the display device 1.

In an exemplary embodiment, the time for the pre-display operation of the panel driving unit 32 may be determined based on the types and the characteristics of the display panel 10 and the panel driving unit 32. In an exemplary embodiment, the time for the pre-display operation may be longer than the predetermined delay time. In such an embodiment, when the first light control signal LCS1 is supplied directly for the light driving unit 34, the light source 20 may provide light for the display panel 10 before the panel driving unit 32 finishes the pre-display operation. When the first light control signal LCS1 has a predetermined delay of about 200 milliseconds (ms) and a time for the pre-display operation of the panel driving unit 32 is about 300 ms, the display panel 10 may display an unexpected image for about 100 ms.

In an exemplary embodiment, the first light control signal LCS1 from the external control device 2 is received by the panel driving unit 32, and light from the light source 20 is supplied for the display panel 10 after the panel driving unit 32 finishes the pre-display operation, such that the display panel 10 is effectively prevented from displaying unexpected images.

In an exemplary embodiment, the time for the pre-display operation of the panel driving unit 32 may be about 300 ms, and the first light control signal LCS1 may be configured to have the light source 20 start its operation and may have a predetermined delay of about 200 ms, such that the second light control signal LCS2 may be obtained by delaying the first light control signal LCS1 by a time greater than or equal to about 100 ms. When the first light control signal LCS1 is configured to control the luminance of the light source 20, the second light control signal LCS2 may be configured to delay the first light control signal LCS1 such that the luminance of the light source 20 is substantially zero for the first 300 ms and has a normal value thereafter.

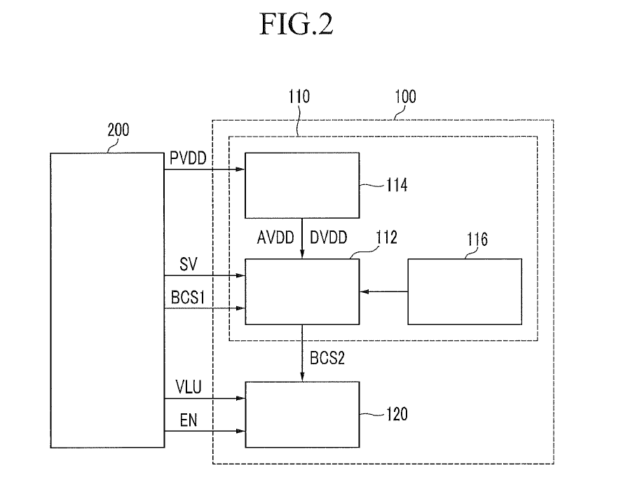

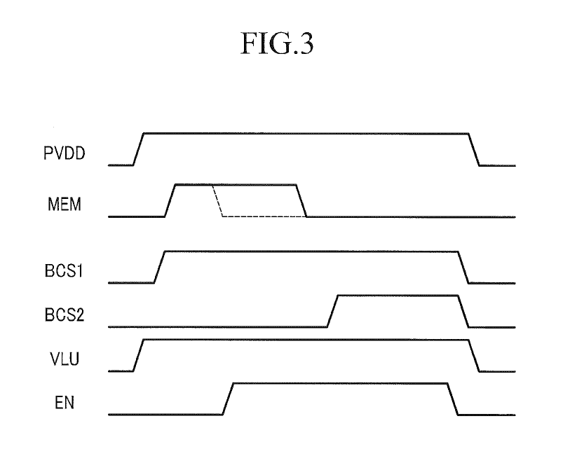

An exemplary embodiment of a driving apparatus of a display device will now be described in detail with reference to FIGS. 2 and 3.

FIG. 2 is a block diagram showing an exemplary embodiment of a driving apparatus of a display device, and FIG. 3 is a waveform diagram showing signals of the driving apparatus shown in FIG. 2.

Referring to FIG. 2, an exemplary embodiment of a driving apparatus 100 of a display device receives several signals from an external control device 200, and includes a panel driving unit 110 and a light driving unit 120.

The signals received by the driving apparatus 100 from the external control device 200 include a panel voltage signal PVDD, an image signal SV, a first luminance control signal BCS1, a lighting voltage signal VLU and a lighting start signal EN, for example, but not being limited thereto. The panel voltage signal PVDD provides voltages for the operations of a display panel (not shown) and the panel driving unit 110, and the lighting voltage signal VLU provides voltages for the operations of a light source (not shown) and the light driving unit 120. The image signal SV includes information of images to be displayed by the display panel, the first luminance control signal BCS1 controls the luminance of the light source, and the lighting start signal EN is configured to have the light driving unit 120 start its operation.

The panel driving unit 110 includes a signal controller 112, a voltage generator 114 and a memory 116.

The memory 116 stores panel information of the display panel, for example, the resolution of the display panel, and may include an electrically erasable programmable read-only memory (“EEPROM”).

The voltage generator 114 receives the panel voltage signal PVDD from the external control device 200 and amplifies or divides the received panel voltage signal PVDD to generate digital voltages DVDD and analog voltages AVDD for the panel driving unit 110 and the display panel.

The signal controller 112 receives the digital voltages DVDD and the analog voltages AVDD from the voltage generator 114, and receives the image signal SV from the external control device 200. The signal controller 112 receives, e.g., reads, the panel information stored in the memory 116. The signal controller 112 processes the image signal SV based on the panel information from the memory 116 and outputs the processed image signal SV to the display panel such that the display panel displays corresponding images. The signal controller 112 may have a pre-display operation time during a time period from the start of the operation of the signal controller 112 to the output of the image signal SV to the display panel, and the panel information stored in the memory 116 may be read during the pre-display operation time.

The signal controller 112 also receives the first luminance control signal BCS1 from the external control device 200, and processes the first luminance control signal BCS1, for example, delays the first luminance control signal BCS1 by a time greater than or equal to the pre-display operation time, to generate a second luminance control signal BCS2 to be outputted to the light driving unit 120.

The light driving unit 120 starts its operation upon receipt of the lighting voltage signal VLU and the lighting start signal EN from the external control device 200, and controls the luminance of the light source based on the second luminance control signal BCS2 from the signal controller 112.

Next, an operation of an exemplary embodiment of the display device shown in FIG. 2 will be described in detail with reference to FIG. 3.

The external control device 200 generates and outputs the panel voltage signal PVDD, the image signal SV, the first luminance control signal BCS1, the lighting voltage signal VLU and the lighting start signal EN, for example, to the driving apparatus 100.

Referring to FIG. 3, the panel voltage signal PVDD and the lighting voltage signal VLU become high voltages earlier than the other signals to provide voltages for the operations of the panel driving unit 110 and the light driving unit 120. In one exemplary embodiment, the high voltage of the panel voltage signal PVDD may be about 3.3 volts (V), and the high voltage of the lighting voltage signal VLU may be about 12 V.

Upon receipt of the panel voltage signal PVDD, the voltage generator 114 generates a digital voltage DVDD and analog voltages AVDD for the display device and the panel driving unit 110. The digital voltage DVDD may be used for the operation of the signal controller 112 or the memory 116. In one exemplary embodiment, for example, the digital voltage DVDD may have a magnitude of about 2.5 V. The analog voltages AVDD may be used for the operation of the display panel. In one exemplary embodiment, the analog voltages AVDD may have a magnitude of about 8 V for gray representation. In one exemplary embodiment, the analog voltages AVDD may have a magnitude of about 21 V and about −10 V for turning on and off thin film transistors in pixels of the display panel, respectively.

Upon receipt of the voltages DVDD and AVDD from the voltage generator 114, the signal controller 112 reads the panel information stored in the memory 116. In an exemplary embodiment, the reading operation of the signal controller 112 may be performed while a read signal MEM is in a high voltage, as shown in FIG. 3.

After finishing the reading operation, the signal controller 112 processes the image signal SV based on the read panel information, and outputs the processed image signal SV to the display panel, which in turn displays a corresponding image.

In an exemplary embodiment, when the first luminance control signal BCS1 becomes a high voltage before the signal controller 112 reads the panel information, the signal controller 112 delays the first luminance control signal BCS1 to produce the second luminance control signal BCS2 that becomes the high voltage after the signal controller 112 reads the panel information.

When both of the lighting start signal EN and the lighting voltage signal VLU become a high voltage, the light driving unit 120 starts its operation. The light driving unit 120 maintains the luminance of the light source to be substantially zero while the second luminance control signal BCS2 maintains a low voltage, and raises the luminance of the light source to a normal value when the second luminance control signal BCS2 becomes the high voltage.

In such an embodiment, the image of the display panel is not displayed until the second luminance control signal BCS2 becomes high, and unexpected images are thereby effectively prevented from being displayed.

Unlike this embodiment, if the first luminance control signal BCS1 from the external control device 200 is directly inputted to the light driving unit 120, the first luminance control signal BCS1 may become the high voltage before the signal controller 112 finishes reading the panel information and before the lighting start signal EN becomes the high voltage. In this case, from a time that the lighting start signal EN becomes the high voltage, the light driving unit 120 starts its operation and simultaneously has the light source in a normal luminance such that the image is displayed on the display panel from that time.

If the lighting start signal EN becomes the high voltage before the signal controller 112 finishes reading the panel information as shown in FIG. 3, the display panel may display an abnormal image since a normally processed image signal is not outputted to the display panel.

As shown with a dotted line in FIG. 3, the lighting start signal EN may be configured to become the high voltage such that the lighting start signal EN becomes high after the signal controller 112 reads the panel information, but the reading operation of the signal controller 112 may be elongated due to, e.g., a change of the specifications of the display panel or the panel driving unit 110. In one case, for example, the function of the signal controller 112 becomes complicated, and thus the capacity of the memory 116 may be increased such that it may take longer to read out the information stored in the memory 116. In this case, the display panel may display an abnormal image as described above.

In an exemplary embodiment, the first luminance control signal BCS1 inputted from the external control device 200 is received by the signal controller 112 and delayed based on the reading time of the panel information, such that the display of abnormal images is effectively prevented.

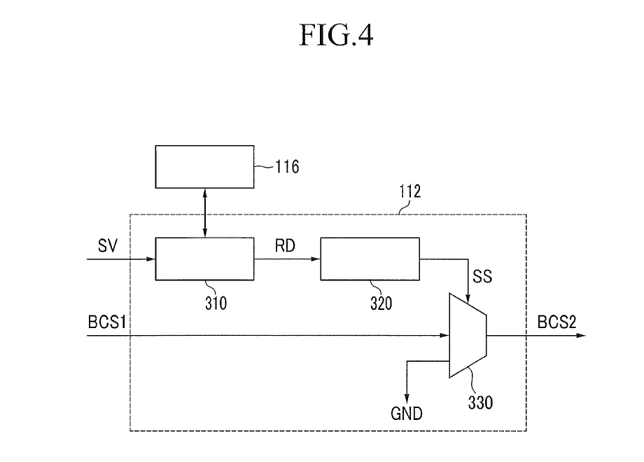

An exemplary embodiment of the signal controller shown in FIG. 2 is described in detail with reference to FIG. 4.

FIG. 4 is a block diagram showing an exemplary embodiment of the signal controller.

An exemplary embodiment of the signal controller 112 may include an image signal processing unit 310, a delay unit 320 and a signal selection unit 330.

In an exemplary embodiment, the image signal processing unit 310 may be connected to the memory 116 that stores the panel information, and may read out the panel information from the memory 116. The image signal processing unit 310 may generate and output a reading completion signal RD, which informs of a completion of the operation of reading the panel information from the memory 116. The reading completion signal RD, for example, may maintain a low voltage before finishing the reading operation and may become a high voltage after the completion of the reading operation.

In such an embodiment, the image signal processing unit 310 processes the image signal SV inputted from outside based on the panel information.

The delay unit 320 delays the reading completion signal RD by predetermined time to generate a selection signal SS, and outputs the selection signal SS to the signal selection unit 330.

The signal selection unit 330 receives a low voltage (e.g., a ground voltage GND) and the first luminance control signal BCS1, selects one of the ground voltage GND and the first luminance control signal BCS1 based on the selection signal SS, and outputs the selected one of the ground voltage GND and the first luminance control signal BCS1 as the second luminance control signal BCS2. In one exemplary embodiment, for example, the ground voltage GND may be selected and outputted when the selection signal SS is in a low state, and the first luminance control signal BCS1 may be selected and outputted when the selection signal SS is in a high state. In such an embodiment, the second luminance control signal BCS2 shown in FIG. 3 may be generated. In an exemplary embodiment, the signal selection unit 330 may include, for example, a multiplexer.

In an alternative exemplary embodiment, the delay unit 320 may be omitted, and the reading completion signal RD may perform the operation of the selection signal SS.

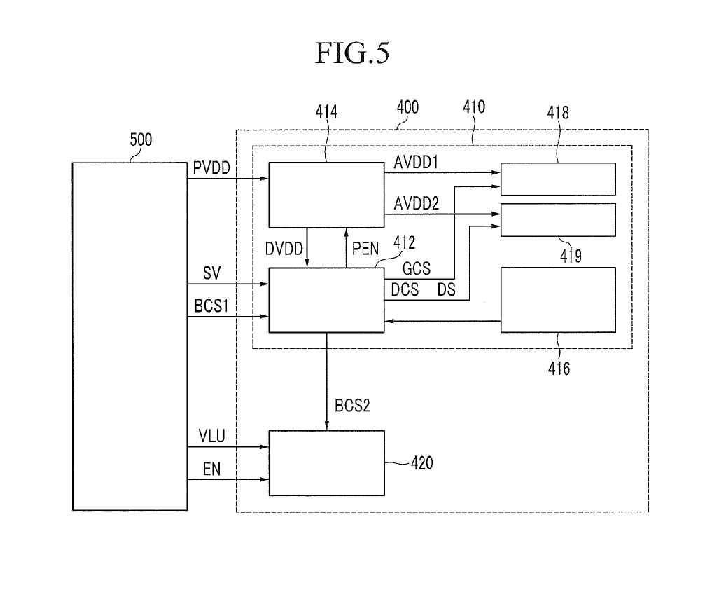

Hereinafter, an alternative exemplary embodiment of the display device will now be described in detail with reference to FIGS. 5 to 7.

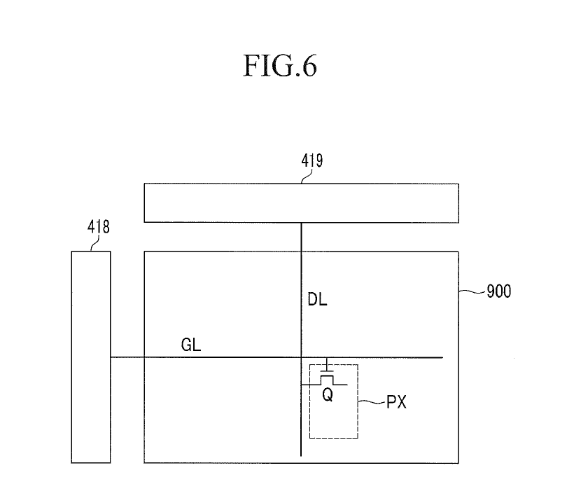

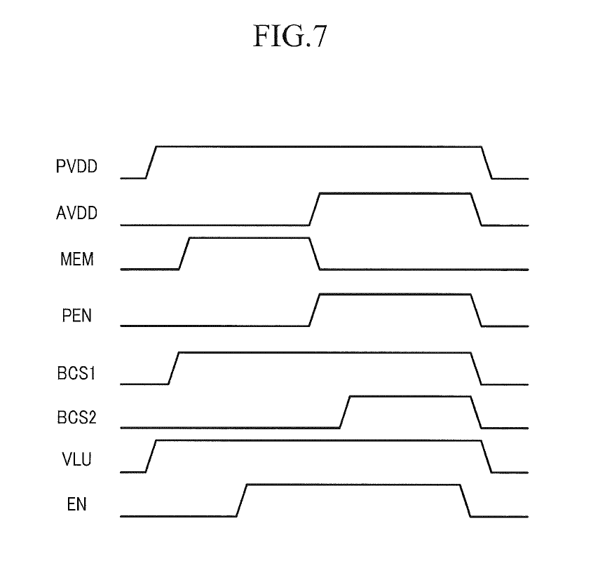

FIG. 5 is a block diagram showing an alternative exemplary embodiment of a display device, FIG. 6 is a diagram showing an exemplary embodiment of a display panel for a display device, and FIG. 7 is a waveform diagram showing signals of the display device shown in FIG. 5.

Referring to FIGS. 5 and 6, an exemplary embodiment of a display device includes a driving apparatus 400 and a display panel 900.

Referring to FIG. 5, the driving apparatus 400 receives several signals from an external control device 500, like the driving apparatus 100 shown in FIG. 2, and includes a panel driving unit 410 and a light driving unit 420. The panel driving unit 410 includes a signal controller 412, a voltage generator 414, a memory 416, a gate driver 418 and a data driver 419.

Referring to FIG. 6, the display panel 900 includes a plurality of gate lines GL, a plurality of data lines DL crossing the gate lines GL, and a plurality of pixels PX. Each of the pixels PX may include at least one switching element, for example, a field effect thin film transistor Q, which is connected to a corresponding gate line GL and a corresponding data line DL.

The driving apparatus 400 in FIG. 5 is substantially the same as the driving apparatus 100 shown in FIG. 2, and any repetitive detailed description thereof will hereinafter be omitted or simplified.

Referring again to FIG. 5, the voltage generator 414 receives a panel voltage signal PVDD from the external control device 500 and amplifies or divides the panel voltage signal PVDD to generate a digital voltage DVDD and analog voltages, e.g., a first analog voltage AVDD1 and a second analog voltage AVDD2, for the panel driving unit 410 and the display panel 900. The voltage generator 414 outputs the digital voltage DVDD to the signal controller 412, and outputs the analog voltages, e.g., the first and second analog voltages AVDD1 and AVDD2, to the gate driver 418 and the data driver 419 based on a voltage generator operation signal PEN received from the signal controller 412.

The signal controller 412 receives the digital voltage DVDD from the voltage generator 414, receives the image signal SV from the external control device 500, and reads out panel information stored in the memory 416.

The signal controller 412 generates a voltage generator operation signal PEN, which informs whether the operation of reading the panel information is completed, and outputs the voltage generator operation signal PEN to the voltage generator 414.

The signal controller 412 converts the image signal SV into a data signal DS, and generates the gate control signal GCS and the data control signal DCS based on the read panel information. The signal controller 412 outputs the gate control signal GCS to the gate driver 418, and outputs the data signal DS and the data control signal DCS to the data driver 419.

Referring to FIGS. 5 and 6, based on the gate control signal GCS, the gate driver 418 generates gate signals using the first analog voltage AVDD1 received from the voltage generator 414, and applies the gate signals to the gate lines GL of the display panel 900. The data driver 419 converts the data signal DS into analog data voltages, based on the data control signal DCS, using the second analog voltage AVDD2 received from the voltage generator 414, and applies the data voltages to the data lines DL of the display panel 900.

The transistor Q connected to the corresponding gate line GL and the corresponding data line DL turns on or turns off in response to a gate signal to transmit the data voltages to a corresponding pixel PX, and the corresponding pixel PX adjusts transmittance of light from a light source based on the data voltages to display corresponding images.

Referring to FIG. 7, in an exemplary embodiment, the voltage generator operation signal PEN may maintain a low voltage until after the signal controller 412 reads the panel information and may become a high voltage after completion of the reading operation. When the voltage generator operation signal PEN has the low voltage, the voltage generator 414 does not output the first and second analog voltages AVDD1 and AVDD2 (that is, the first and second analog voltages AVDD1 and AVDD2 have substantially zero values). When the voltage generator operation signal PEN becomes a high voltage, the voltage generator 414 outputs the first and second analog voltages AVDD1 and AVDD2 (that is, the first and second analog voltages AVDD1 and AVDD2 have high values).

In such an embodiment, the first and second analog voltages AVDD1 and AVDD2 are not outputted from the voltage generator 414 until the reading operation of the panel information is completed, and the display panel 900 is thereby effectively prevented from being supplied with abnormal voltages through the gate driver 418 or the data driver 419. In FIG. 7, AVDD denotes the analog voltages AVDD1 or AVDD2.

In such an embodiment, the operations related to the light driving unit 420 of FIG. 5 is substantially the same as the operations related to the light driving unit 120 FIG. 2, and any repetitive detailed description thereof will be omitted.

In an exemplary embodiment, the signal controller 412 of the driving apparatus 400 may be substantially the same as the signal controller 112 shown in FIG. 4, except that the reading completion signal RD shown in FIG. 4 may be used as the voltage generator operation signal PEN. In an exemplary embodiment, the image signal processing unit 310 (shown in FIG. 4) may output the reading completion signal RD to the voltage generator 414 (shown in FIG. 5) as the voltage generator operation signal PEN and also output the reading completion signal RD to the delay unit 320 (shown in FIG. 4). The voltage generator 414 (shown in FIG. 5) begins outputting the first and second analog voltages AVDD1 and AVDD2 when the voltage generator operation signal PEN, which is the reading completion signal RD, becomes a high voltage. The first and second analog voltages AVDD1 and AVDD2 have substantially zero values at the beginning of their outputs, and it may take time for the analog voltages AVDD1 and AVDD2 to reach target values from the substantially zero values. In such an embodiment, the time delay between the signal selection signal SS and the voltage generator operation signal PEN, which is the reading completion signal RD, may be longer than the rising time of the first and second analog voltages AVDD1 and AVDD2 from the substantial zeros to the target values such that the second luminance control signal BCS2 is effectively prevented from being outputted during the rising time, and abnormal images are effectively prevented from being displayed on the display panel 900.

In an exemplary embodiment, the gate driver 418 may be provided, e.g., manufactured, in a separate semiconductor chip. In an alternative exemplary embodiment, the gate driver 418 may be disposed in the display panel 900. In such an embodiment, the gate driver 418 may be provided, e.g., formed, by a process by which the thin film transistor Q is formed.

In an exemplary embodiment, the data driver 419 may be provided, e.g., integrated, into a single chip together with the signal controller 412. In an alternative exemplary embodiment, the data driver 419 may be manufactured in an individual chip separated from the signal controller 412. In such an embodiment, the data driver 419 may be disposed, e.g., mounted, on the display panel 900.

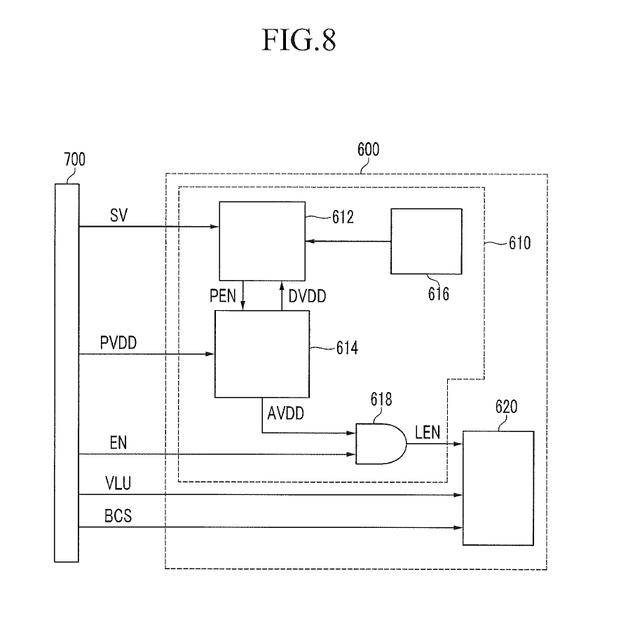

Another alternative exemplary embodiment of the display device will now be described in detail with reference to FIG. 8.

FIG. 8 is a block diagram showing another alternative exemplary embodiment of a display device.

Referring to FIG. 8, an exemplary embodiment of a driving apparatus 600 of a display device receives several signals from an external control device 700, and includes a panel driving unit 610 and a light driving unit 620. The signals that the driving apparatus 600 receives from the external control device 700 include a panel voltage signal PVDD, an image signal SV, a luminance control signal BCS, a lighting voltage signal VLU and a lighting start signal EN, for example. In such an embodiment, the functions of the signals may be substantially similar to the signals shown in FIGS. 2 and 5, and the luminance control signal BCS may be substantially the same as the first luminance control signal BCS1, shown in FIGS. 2 and 5.

The panel driving unit 610 includes a signal controller 612, a voltage generator 614, a memory 616 and an AND gate 618. The panel driving unit 610 may further include a gate driver (not shown in FIG. 8) and a data driver (not shown in FIG. 8).

The operations of the voltage generator 614 and the memory 616 may be substantially the same as the voltage generator 414 and the memory 416 shown in FIG. 5, respectively.

In an exemplary embodiment, the signal controller 612 of FIG. 8 is substantially the same as the signal controller 412 shown in FIG. 5 except that the signal controller 612 of FIG. 8 does not receive the luminance control signal BCS from the external control device 700 and does not output a luminance control signal to the light driving unit 620.

In an exemplary embodiment, the AND gate 618 receives the lighting start signal EN from the external control device 700, and receives an analog voltage AVDD from the voltage generator 614. The AND gate 618 outputs a logical product (conjunction) of the lighting start signal EN and the analog voltage AVDD as a lighting delay signal LEN.

In an exemplary embodiment, the light driving unit 620 receives the lighting voltage signal VLU and the luminance control signal BCS from the external control device 700 and receives the lighting delay signal LEN from the AND gate 618.

In an exemplary embodiment, a light source (not shown) may provide light for a display panel (not shown) in response to the lighting delay signal LEN from the light driving unit 620. In such an embodiment, the lighting delay signal LEN is the logical product (conjunction) of the analog voltage AVDD and the lighting start signal EN, the lighting delay signal LEN becomes a high voltage when both the analog voltage AVDD and the lighting start signal EN have high voltages.

In an exemplary embodiment, as shown in FIG. 7, the analog voltage AVDD becomes high after the signal controller 612 reads the panel information, and the lighting delay signal LEN also becomes high after the completion of reading the panel information.

In an exemplary embodiment, the light driving unit 620 starts its operation, e.g., of providing light for the display panel, after the signal controller 612 reads the panel information, such that abnormal images is effectively prevented from being displayed on the display panel during the reading operation for the panel information.

In an exemplary embodiment, the AND gate 618 may be disposed outside the panel driving unit 610 and may be implemented separately.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A driving apparatus of a display device comprising:
a panel driving unit that receives a panel control signal and a first light control signal from an external device, drives a display panel of the display device based on the panel control signal, processes the first light control signal, and outputs the processed first light control signal as a second light control signal; and
a light driving unit that drives a light source of the display device based on the second light control signal,
wherein the second light control signal is configured to have the light source provide light for the display panel after a completion of a pre-display operation of the panel driving unit.

2. The driving apparatus of claim 1, wherein
the second light control signal is obtained by delaying the first light control signal,
the delay between the first light control signal and the second light control signal is greater than or equal to a pre-display operation time, during which the pre-display operation of the panel driving unit is performed.

3. The driving apparatus of claim 1, wherein the panel driving unit comprises:
a memory that stores panel information of the display panel; and
a signal controller that receives an image signal from the external control device, reads the panel information stored in the memory, and processes the image signal based on the read panel information,
wherein the pre-display operation comprises the reading of the panel information.

4. The driving apparatus of claim 3, wherein
the signal controller processes the first light control signal to generate the second light control signal,
the first light control signal includes information on luminance of the light source, and
the second light control signal is configured to have the luminance of the light source substantially equal to zero during the pre-display operation, and configured to raise the luminance of the light source after the completion of the pre-display operation.

5. The driving apparatus of claim 4, wherein the signal controller comprises:
an image signal processing unit that receives the image signal from the external control device, reads the panel information stored in the memory, generates a reading completion signal, and processes the image signal based on the read panel information, wherein the reading completion signal informs whether the reading of the panel information is completed; and
a signal selection unit that selects one of the first light control signal and a low voltage based on the reading completion signal, and outputs the selected one of the first light control signal and the low voltage as the second light control signal.

6. The driving apparatus of claim 5, wherein
the signal controller converts the image signal from the external control device to a data signal, and generates a gate control signal and a data control signal based on the read panel information,
the panel driving unit further comprises:
a voltage generator that receives a panel voltage signal from the external control device, and generates a digital voltage and an analog voltage based on the panel voltage signal;
a gate driver that generates a gate signal using the analog voltage from the voltage generator, and applies the gate signal to the display panel based on the gate control signal; and
a data driver that converts the data signal into a data voltage using the analog voltage from the voltage generator, and applies the data voltage to the display panel based on the data control signal,
the voltage generator receives the reading completion signal, and adjusts an output timing of the analog voltage based on the reading completion signal, and
the display panel displays an image based on the data voltage.

7. The driving apparatus of claim 4, wherein the signal controller comprises:
an image signal processing unit that receives the image signal from the external control device, reads the panel information stored in the memory, generates a reading completion signal, and processes the image signal based on the read panel information, wherein the reading completion signal informs whether the reading of the panel information is completed;
a delay unit that delays the reading completion signal; and
a signal selection unit that selects one of the first light control signal and the low voltage based on the delayed reading completion signal, and outputs the selected one of the first light control signal and the low voltage as the second light control signal.

8. The driving apparatus of claim 3, wherein
the first light control signal includes information on a timing to start an operation of the light driving unit, and
the second light control signal is configured to have the light driving unit start the operation thereof after the completion of the pre-display operation of the panel driving unit.

9. The driving apparatus of claim 8, wherein
the signal controller generates a voltage generator operation signal that informs whether the reading of the panel information is completed,
the signal controller converts the image signal from the external control device to a data signal, and generates a gate control signal and a data control signal based on the read panel information,
the panel driving unit further comprises:
a voltage generator that generates a digital voltage and an analog voltage;
an AND gate that receives the first light control signal from the external control device, receives the analog voltage from the voltage generator, and performs a logical product of the first light control signal and the analog voltage to generate the second light control signal;
a gate driver that generates a gate signal using the analog voltage from the voltage generator, and applies the gate signal to the display panel based on the gate control signal; and
a data driver that converts the data signal into a data voltage using the analog voltage from the voltage generator, and applies the data voltage to the display panel based on the data control signal,
the voltage generator receives the voltage generator operation signal, and adjusts an output timing of the analog voltage based on the voltage generator operation signal, and
the display panel displays an image based on the data voltage.

10. The driving apparatus of claim 1, wherein
the first light control signal includes information on luminance of the light source, and
the second light control signal is configured to have the luminance of the light source substantially equal to zero during the pre-display operation of the panel driving unit, and is configured to raise the luminance of the light source after the completion of the pre-display operation of the panel driving unit.

11. The driving apparatus of claim 10, wherein the panel driving unit comprises:
a memory that stores panel information of the display panel; and
a signal controller comprising:
an image signal processing unit that receives an image signal from the external control device, reads the panel information stored in the memory, generates a reading completion signal, and processes the image signal based on the read panel information, wherein the reading completion signal informs whether the reading of the panel information is completed;
a delay unit that delays the reading completion signal, and generates a selection signal; and
a signal selection unit that selects one of the first light control signal and a low voltage based on the selection signal, and outputs the selected one of the first light control signal and the low voltage as the second light control signal.

12. The driving apparatus of claim 1, wherein
the first light control signal includes information on a timing to start an operation of the light driving unit, and
the second light control signal is configured to have the light driving unit to start the operation thereof after the completion of the pre-display operation of the panel driving unit.

13. The driving apparatus of claim 1, wherein the panel driving unit comprises:
a memory that stores panel information of the display panel; and
a signal controller that receives an image signal from the external control device, reads the panel information stored in the memory, generates a voltage generator operation signal, converts the image signal from the external control device to a data signal, and generates a gate control signal and a data control signal based on the read panel information, wherein the voltage generator operation signal informs whether the reading of the panel information is completed,
a voltage generator that generates a digital voltage and an analog voltage;
an AND gate that receives the first light control signal from the external control device, receives the analog voltage from the voltage generator, and performs a logical product of the first light control signal and the analog voltage to generate the second light control signal;
a gate driver that generates a gate signal using the analog voltage from the voltage generator and applies the gate signal to the display panel based on the gate control signal; and
a data driver that converts the data signal into a data voltage using the analog voltage from the voltage generator and applies the data voltage to the display panel based on the data control signal,
wherein the voltage generator receives the voltage generator operation signal and adjusts an output timing of the analog voltage based on the voltage generator operation signal, and
the display panel displays an image based on the data voltage.

14. A driving apparatus of a display device comprising:
a panel driving unit that receives a panel voltage signal and an image signal from an external device, drives a display panel of the display device based on the panel voltage signal and the image signal, and generates an analog signal;
an AND gate that receives a lighting start signal from the external control device, and outputs a lighting delay signal based on a logical product of the lighting start signal and the analog voltage; and
a light driving unit that receives a light source voltage signal and a luminance control signal from the external control device, receives the lighting delay signal from the AND gate, starts an operation thereof based on the light source voltage signal and the lighting delay signal, and drives a light source of the display device based on the luminance control signal,
wherein the lighting delay signal is configured to have the light driving unit start the operation thereof after a completion of a pre-display operation of the panel driving unit.

15. The driving apparatus of claim 14, wherein the panel driving unit comprises:
a voltage generator that receives the panel voltage signal, and generates a digital voltage and an analog voltage based on the panel voltage signal;
a memory that stores panel information of the display panel;
a signal controller that receives the image signal, reads the panel information stored in the memory, generates a voltage generator operation signal, converts the image signal into a data signal, and generates a gate control signal and a data control signal based on the read panel information, wherein the voltage generator operation signal informs whether the reading of the panel information is completed;
a gate driver that generates a gate signal using the analog voltage from the voltage generator, and applies the gate signal to the display panel based on the gate control signal; and
a data driver that converts the data signal into a data voltage using the analog voltage from the voltage generator, and applies the data voltage to the display panel based on the data control signal,
wherein the pre-display operation comprises the reading of the panel information,
the voltage generator receives the voltage generator operation signal and adjusts an output timing of the analog voltage based on the voltage generator operation signal, and
the display panel displays an image based on the data voltage.

16. A method of driving a display device, the method comprising:
receiving a panel voltage signal, an image signal, a lighting voltage signal, a luminance control signal and a lighting start signal from an external control device, wherein a display panel of the display device operates based on the panel voltage signal and the image signal, and a light source of the display device operates based on the lighting voltage signal, the luminance control signal, and the lighting start signal;
reading panel information of the display panel;
processing the image signal based on the read panel information to drive the display panel;
generating a delay signal by delaying one of the luminance control signal and the lighting start signal by a time greater than or equal to a time for reading the panel information of the display panel; and
supplying the display panel with light from the light source based on the delay signal.
